(19) United States
(12) Patent Application Publication
(10) Pub. No.: US 2021/0097694 A1
(43) Pub. Date: Apr. 1, 2021

(54) MOTION DETECTION DEVICE AND METHOD

(71) Applicant: Samsung Electronics Co., Ltd., Gyeonggi-do (KR)

(72) Inventors: Dojun Yang, Gyeonggi-do (KR); Sangyeon Kim, Gyeonggi-do (KR); Sangbae Park, Gyeonggi-do (KR); Kwangil Hwang, Gyeonggi-do (KR)

(73) Assignee: Samsung Electronics Co., Ltd.

(21) Appl. No.: 16/841,280

(22) Filed: Apr. 6, 2020

(30) Foreign Application Priority Data
Sep. 27, 2019 (KR) 10-2019-0119453

(51) Int. Cl. G06T 7/20; G06T 7/55

(52) U.S. Cl. CPC G06T 7/20; G06T 2207/20084; G06T 2207/20081; G06T 7/55

(57) ABSTRACT

A motion detection device is provided. The motion detection device includes a first dynamic vision sensor (DVS), a memory, a communication circuit, and at least one processor, wherein the at least one processor is configured to receive a plurality of images including a movable object using the first DVS for a predetermined time, generate data for determining a kind of motion of the moveable object based on a motion vector of the plurality of images, transmit the generated data to a cloud, and determine the kind of motion of the moveable object based on information received from the cloud.

### CROSS-REFERENCE TO RELATED APPLICATION(S)

This application is based on and claims priority under 35 U.S.C. § 119 to Korean Patent Application No. 10-2019-0119453, filed on Sep. 27, 2019, in the Korean Intellectual Property Office, the disclosure of which is incorporated by reference herein in its entirety.

### BACKGROUND

### 1. Field

The disclosure relates to a motion detection device and method for determining a kind of motion of an object using a dynamic vision sensor (DVS).

### 2. Description of Related Art

Falling is common to advanced age and is a major cause of death for senior citizens or seniors. Research is underway to elicit and analyze factors that may lead to falls in advanced age and thereby prevent falls.

Fall accidents may happen to all age groups although common to the elderly population. The percentage of falls in advanced age is gradually on the rise. Falling may result in severe injuries or even death.

A fall may also cause significant deterioration in quality of life. About 20% to 30% of falls in advanced age may result in injuries, such as bruises, hipbone fractures, or head injuries. Falling accidents are expected to steadily increase as the elderly population increases. Thus, there are being proposed various approaches to detect falling.

Detecting a motion of an object (e.g., a human being) is among the schemes for detecting falling.

Use of an ordinary 3-dimensional (3D) camera, however, may cause an invasion-of-privacy issue as the object captured is exposed and may also increase costs.

Further, use of a 3D camera requires high-performance and a high-volume of computation to detect a motion of an object (e.g., a human being) in an image obtained using the 3D camera.

### SUMMARY

An aspect of the present disclosure provides a motion detection device and a method for determining a kind of motion of an object using a DVS.

In accordance with an embodiment, a motion detection device is provided. The motion detection device includes a first DVS, a memory, a communication circuit, and at least one processor, wherein the at least one processor is configured to receive a plurality of images including a movable object using the first DVS for a predetermined time, generate data for determining a kind of motion of the moveable object based on a motion vector of the plurality of images, transmit the generated data to a cloud, and determine the kind of motion of the moveable object based on information received from the cloud.

In accordance with an embodiment, a method of detecting motion by a motion detection device is provided. The method includes receiving a plurality of images including a movable object using a first DVS for a predetermined time, generating data for determining a kind of motion of the moveable object based on a motion vector of the plurality of images, transmitting the generated data to a cloud, and determining the kind of motion of the moveable object based on information received from the cloud.

### BRIEF DESCRIPTION OF THE DRAWINGS

The above and other aspects, features, and advantages of certain embodiments of the present disclosure will be more apparent from the following detailed description taken in conjunction with the accompanying drawings, in which:

FIG. 1 is a block diagram of a motion detection system according to an embodiment;

FIG. 2 is a flowchart of a method of training a learning model for determining a kind of motion of an object according to an embodiment;

FIG. 3 is an illustration of training a learning model for determining a kind of motion of an object according to an embodiment;

FIG. 4 is an illustration of generating a motion vector image including a motion vector according to an embodiment;

FIG. 5 is a block diagram of a motion detection device according to an embodiment;

FIG. 6 is an illustration of a DVS according to an embodiment;

FIG. 7 is a timing chart for a certain pixel of a DVS according to an embodiment;

FIG. 8 is a flowchart of a method of a motion detection device according to an embodiment;

FIG. 9 is a flowchart of a method of a motion detection device according to an embodiment;

FIG. 10 is an illustration of an operation of motion detection by a motion detection device according to an embodiment;

FIG. 11 is a block diagram of a motion detection device according to an embodiment;

FIG. 12 is a flowchart of a method of a motion detection device according to an embodiment;

FIG. 13 is an illustration of an operation of motion detection by a motion detection device according to an embodiment;

FIG. 14 is a block diagram of a motion detection device according to an embodiment;

FIG. 15 is a flowchart of a method of a motion detection device according to an embodiment;

FIG. 16 is an illustration of an operation of motion detection by a motion detection device according to an embodiment; and

FIG. 17 is an illustration of motion detection by a motion detection device according to an embodiment.

### DETAILED DESCRIPTION

The terms used herein are briefly described below, and the disclosure is described in detail below.

For use in the disclosure, common terms widely used as possible have been chosen considering functions in the disclosure, but the terms may be varied depending on the intent of one of ordinary skill in the art, case law, or the advent of new technologies. In certain cases, some terms are arbitrarily selected, and in such case, their detailed definitions may be given in the relevant parts thereof. Accordingly, the terms used herein should be determined based on their meanings and the overall disclosure, rather than by the terms themselves.

When an element includes another element, the element may further include the other element, rather than excluding the other element, unless particularly stated otherwise. Further, the terms “unit,” “module,” or “part” as used herein to denote a unit processing at least one function or operation, where a unit, module, or part may be implemented in hardware, software, or a combination thereof.

Embodiments of the disclosure are described below with reference to the accompanying drawings in such a detailed manner as to be easily practiced by one of ordinary skill in the art. However, the present disclosure may be implemented in other various forms and is not intended to be limited to the embodiments set forth herein. For clarity of the disclosure, irrelevant parts are removed from the accompanying drawings, and similar reference denotations are used to refer to similar elements throughout the present disclosure.

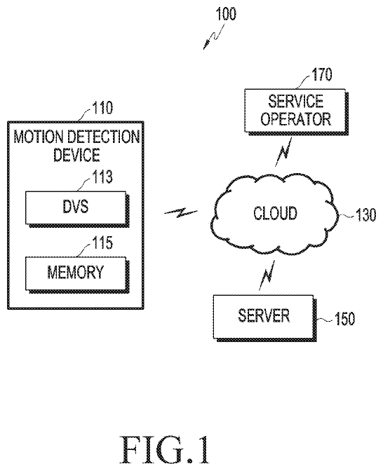

FIG. 1 is a block diagram of a motion detection system 100 according to an embodiment.

Referring to FIG. 1, the motion detection system 100 may include a motion detection device 110 and a cloud 130.

The motion detection device 110 may include one or more (e.g., two) DVSs 113 and a memory 115. The motion detection device 110 may be installed in a position where movable objects may be captured or recorded (e.g., a wall of a living room, a bathroom, and/or a bedroom).

The motion detection device 110 may continuously receive a plurality of images using the DVS 113 for a predetermined time, individually detect motion vectors from the plurality of images, generate data (e.g., depth information (e.g., a depth map)) for determining a kind of motion of an object based on the motion vectors, and apply the generated data to a learning model, thereby determining the kind of motion of an object in the plurality of images.

The motion detection device 110 may transmit the data (e.g., depth information (e.g., a depth map)) to the cloud 130 that stores a learning model for determining the kind of motion of an object and determine a kind of motion of the object in the plurality of images based on information received from the cloud 130.

The motion detection device 110 may apply the data (e.g., depth information (e.g., a depth map)) to a learning model for determining a kind of motion of an object, which is stored in the memory 115, thereby determining the kind of motion of the object in the plurality of images.

The DVS 113 is an image sensor that adopts the scheme in which the human iris receives information. The DVS 113 is a sensor capable of obtaining image data for moving objects.

The DVS 113 may transmit received images to a processor only when there is a local change in a pixel unit due to movement. In other words, the DVS 113 may transmit images to the processor only when a moving event occurs. As such, the DVS 113 does not perform image processing when an object is stationary and, when the object is moving, the DVS 113 may perform measurement on the moving object and transmit images to the processor, thereby preventing data waste which ordinary image sensors would cause by continuously sending out image frames.

The DVS 113 may have a resolution in micro-seconds. The DVS 113 may have a time resolution superior to high-speed cameras that capture a few thousands of frames per second (FPS) (e.g., high-speed frame>1K FPS). With reduced power consumption and data storage requirements, the DVS 113 may increase the dynamic range (which is a range of brightness the DVS 113 may differentiate).

Since the image obtained by the DVS 113 is represented as a contour of the moving object, it may be useful for the protection of privacy of the monitored object. The DVS 113 may detect the movement of the object even in very low light.

The cloud 130 may store a pre-trained learning model (e.g., a deep-learning model) for determining a kind of motion of an object.

Upon receiving data (e.g., depth information (e.g., a depth map)) for determining a kind of motion of an object in a plurality of images from the motion detection device 110, the cloud 130 may apply the data (e.g., depth information (e.g., a depth map)) to a learning model and transmit information of a result of the application of the data to the learning model to the motion detection device 110.

Upon receiving the data (e.g., depth information (e.g., a depth map)) for determining the kind of motion of the object in the plurality of images and distance information between the motion detection device 110 and the object in the plurality of images from the motion detection device 110, the cloud 130 may apply the data (e.g., depth information (e.g., a depth map)) and the distance information to the learning model and transmit information of the result of the application of the data to the learning model to the motion detection device 110.

The cloud 130 may receive a learning model trained to be able to determine a kind of motion of an object from a service operator 170 and/or a server 150 and store the learning model.

The cloud 150 may periodically or selectively receive learning data for updating the learning model from the service operator 170 and/or the server 150 and update the learning model.

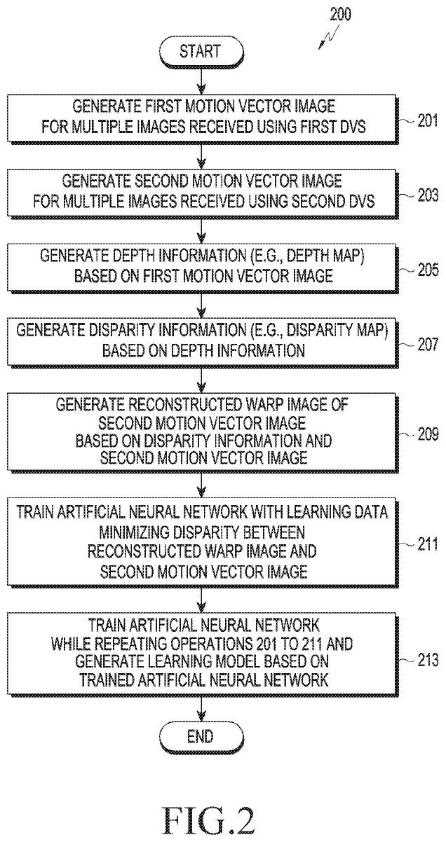

FIG. 2 is a flowchart 200 of a method of training a learning model for determining a kind of motion of an object according to an embodiment.

Referring to FIG. 2, the operation of training the learning model may be performed by an external device. The external device may include various external devices capable of training the learning model for determining a kind of motion of an object, as well as a service operator (e.g., the service operator 170 of FIG. 1) and/or a server (e.g., the server 150 of FIG. 1).

In step 201, the external device may generate a plurality of first motion vector images for a plurality of images using a first DVS (e.g., a left-hand DVS) of two DVSs.

The external device may sequentially receive a plurality of images using the first DVS for a predetermined time and divide the images into a plurality of groups, each of which includes a predetermined number of images, in the order of obtaining the plurality of images. The external device may generate a first motion vector image for a plurality of images in a first group among the plurality of groups.

In step 203, the external device may generate a plurality of second motion vector images for a plurality of images received using a second DVS (e.g., a right-hand DVS) of the two DVSs.

The external device may sequentially receive a plurality of images using the second DVS for a predetermined time and divide the images into a plurality of groups, each of which includes a predetermined number of images, in the order of obtaining the plurality of images. The external device may generate a first motion vector image for a plurality of images in a second group among the plurality of groups.

In step 205, the external device may generate depth information (e.g., a depth map) based on the first motion vector image.

If inputting the first motion vector image to an artificial neural network, the external device may generate the depth information (e.g., a depth map) via the artificial neural network.

In step 207, the external device may generate disparity information (e.g., a disparity map) based on the depth information (e.g., a depth map).

The external device may generate the disparity information (e.g., a disparity map) based on Equation (1) below.

d=f*b/D (1)

where d: disparity, f: focal, b: distance between, D: depth

In step 209, the external device may generate a reconstructed warp image for the second motion vector image based on the disparity information (e.g., a disparity map).

The external device may generate a reconstructed warp image based on Equation (2) below.

I_{w}(X)=I₂(X+d(x)) (2)

where Iw: reconstructed warp image

X: each pixel value of image

I₂: second motion vector image

d: disparity

In step 211, the external device may train the artificial neural network with learning data that may minimize the disparity between the reconstructed warp image and the second motion vector image.

The external device may generate learning data that may minimize the disparity between the reconstructed warp image and the second motion vector image based on Equation (3) below.

∥I_{w}(x)−I₂(x)∥ (3)

where Iw: reconstructed warp image

X: each pixel value of image

I₂: second motion vector image

In step 213, the external device may generate learning data based on the motion vector for the plurality of images in each of the plurality of groups obtained using the first DVS (e.g., the left-hand DVS) and the motion vector for a plurality of images in each of the plurality of groups obtained using the second DVS (e.g., the right-hand DVS) while repeating steps 201 to 211, train the artificial neural network with the generated learning data, and generate a learning model based on the trained artificial neural network.

The external device may generate learning data based on the motion vector for the plurality of images and distance information between the first DVS or second DVS and the object in the plurality of images, train the artificial neural network with the generated learning data, and generate a learning model based on the trained artificial neural network.

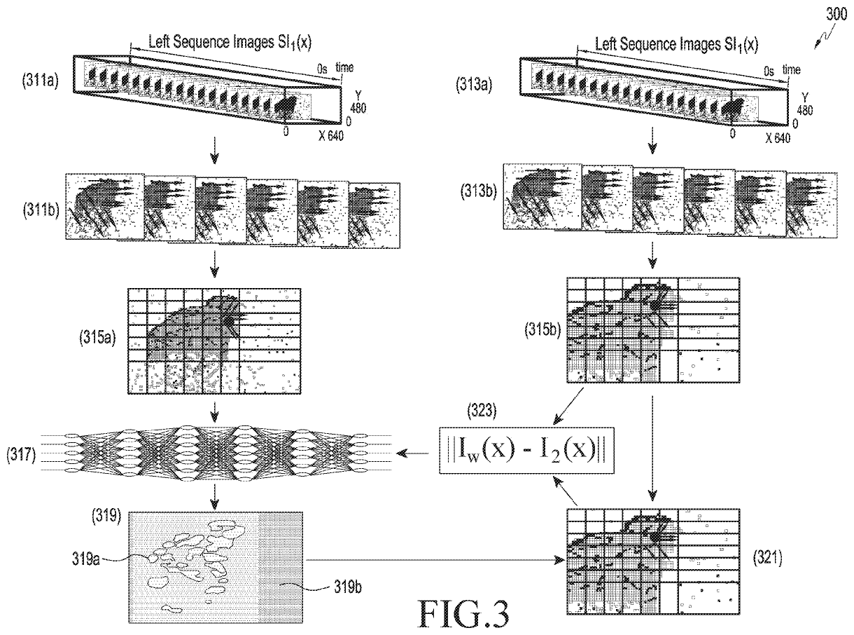

FIG. 3 is an illustration 300 of training a learning model for determining a kind of motion of an object according to an embodiment.

Referring to FIG. 3, an operation of training the learning model may be performed by an external device. The external device may include various external devices capable of training the learning model for determining a kind of motion of an object, as well as a service operator 170 and/or a server 150.

In step 311a, the external device may receive a plurality of images using a first DVS (e.g., a left-hand DVS).

In step 313a, the external device may divide the plurality of images into a plurality of groups and generate a plurality of first motion vector images including a pixel motion vector for each of the plurality of groups.

In step 315a, the external device may select one of the plurality of first motion vector images.

In step 311b, the external device may receive a plurality of images using a second DVS (e.g., a right-hand DVS) while receiving a plurality of images using the first DVS (e.g., the left-hand DVS) in step 311a.

In step 313b, the external device may divide the plurality of images into a plurality of groups and generate a plurality of second motion vector images including a pixel motion vector for each of the plurality of groups while generating the plurality of first motion vector images in step 313a.

In step 315b, the external device may select one of the plurality of second motion vector images while selecting one of the plurality of first motion vector images in step 315a.

In step 317, the external device may input the first motion vector image selected in step 315a to an artificial neural network.

In step 319, the external device may predict and generate depth information (e.g., a depth map) for the first motion vector image via the first motion vector image-inputted to the artificial neural network. The external device may differentiate between a portion 319a (e.g., a moving object/foreground) where motion is detected and a portion 319b where no motion is detected, predict and generate depth information (e.g., a depth map) 319 for the motion-detected portion 319a (e.g., a moving object/foreground), and perform tracking on the object in the image.

The external device may generate disparity information (e.g., a disparity map) by applying the depth information (e.g., a depth map) to Equation (1) above.

In step 321, the external device may apply the disparity information (e.g., a disparity map) and the second motion vector image selected in step 315b to Equation (2) above, thereby generating a reconstructed warp image for the second motion vector image.

In step 323, the external device may generate learning data which may minimize the disparity between the reconstructed warp image (I_{w}) and the second motion vector image (I₂) by applying the reconstructed warp image and the second motion vector image to Equation (3) above, train the artificial neural network with the learning data, and generate a learning model (e.g., a deep-learning model) capable of determining the kind of motion of the object based on the trained artificial neural network.

The learning model (e.g., a deep-learning model) generated by the operations of FIG. 3 may be stored in a cloud 130 and/or the memory 115 of the motion detection device 110.

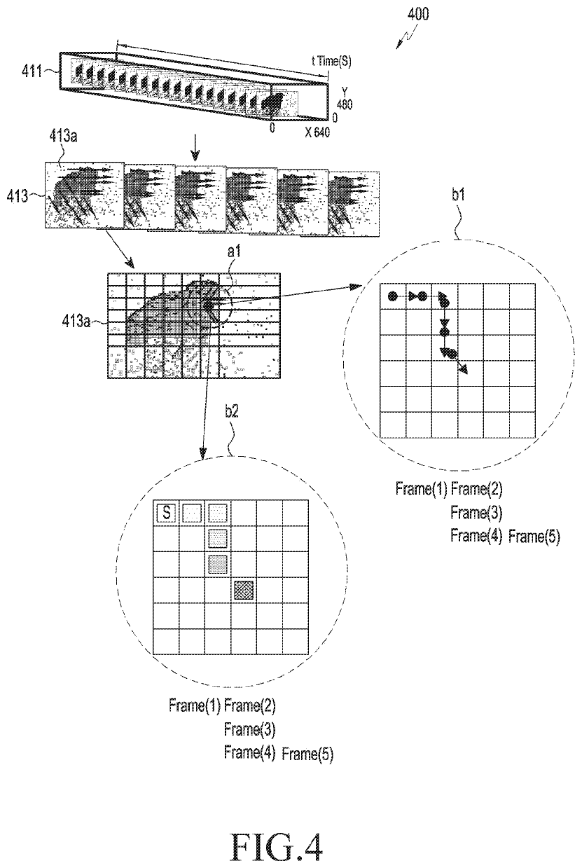

FIG. 4 is an illustration 400 of generating a motion vector image including a motion vector according to an embodiment.

Referring to FIG. 4, generation of the motion vector may be performed by an external device and/or a motion detection device. The external device may include various external devices capable of generating motion vector images, as well as a service operator 170 and/or a server 150. Although an example operation of detecting a motion vector for a plurality of images obtained using a first DVS (e.g., a left-hand dynamic vision sensor) of two DVSs is described with reference to FIG. 4, the description may also apply to an operation of detecting a motion vector for a plurality of images obtained using a second DVS (e.g., a right-hand dynamic vision sensor) of the two DVSs.

A device (e.g., an external device and/or a motion detection device) may receive a plurality of images 411 using a first DVS (e.g., the left-hand DVS).

The device may divide the plurality of images 411 into a plurality of groups and generate a plurality of first motion vector images 413 including a pixel motion vector for each of the plurality of groups.

Among various methods for representing motion features between images in connection with generation of the first motion vector images, an optical flow (OF) method is described below.

For example, (u(x,y), v(x,y)) may be an OF vector field (horizontal and vertical components of OF in each point (x,y)) between frame Iₜ and Iₜ₊₁.

Vₜ₊₁(x,y)=Vₜ(x+u(x,y),y+v(x,y)).

In other words, the x,y point in the image at time t+1 may be represented as vector shifts from x,y on the Vₜ image at prior time t to u(x,y) in the horizontal direction and v(x,y) in the vertical direction.

Thus, assuming that one 413a of the plurality of motion vector images 413 is extracted from five images (e.g., frame(1), frame(2), frame(3), frame(4), and frame(5)), the horizontal and vertical motion vector shift flow of the pixel corresponding to the x,y coordinates at time t to time t+4 may be represented as follows.

uₜ(x,y),vₜ(x,y)->uₜ₊₁(x,y),vₜ₊₁(x,y)->uₜ₊₂(x,y),vₜ₊₂(x,y)->uₜ₊₃(x,y),vₜ₊₃(x,y)->uₜ₊₄(x,y),vₜ₊₄(x,y).

The horizontal and vertical motion vector shift flow of the pixel corresponding to the x,y coordinates at time t to time t+4 may be shown with arrows as indicated with b1 or may be shown in different colors as indicated with b2.

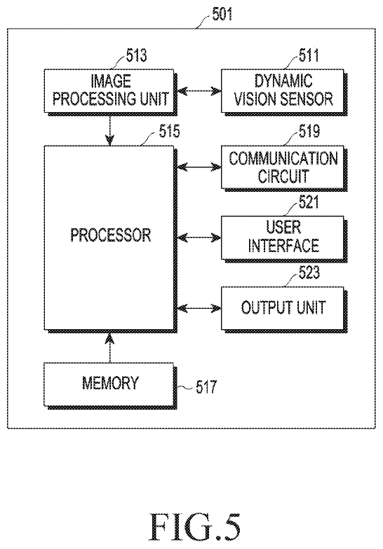

FIG. 5 is a block diagram of a motion detection device 501 according to an embodiment.

Referring to FIG. 5, the motion detection device 501 may include a DVS 511, an image processing unit 513, a processor 515, a memory 517, a communication circuit 519, a user interface 521, and an output unit 523.

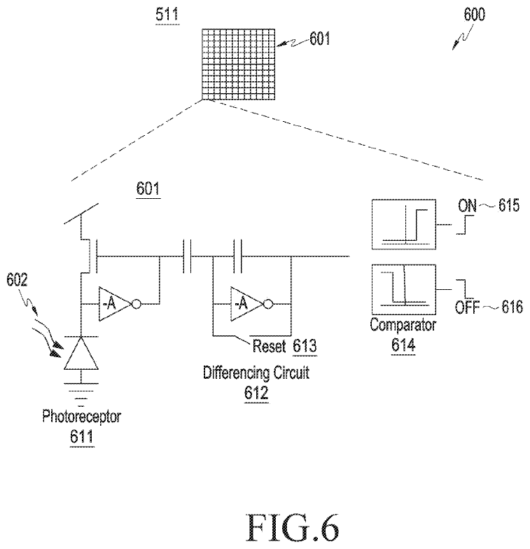

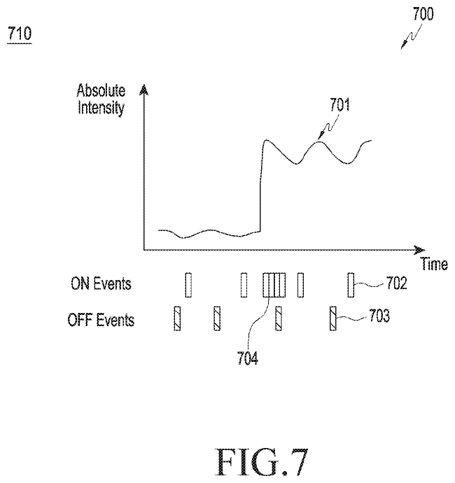

The DVS 511 is an image sensor that adopts the scheme in which the human iris receives information. The DVS 511 is a sensor capable of obtaining image data for moving objects. For example, the DVS 511 may transmit images to the processor 515 only when there is a local change in the pixel unit due to movement. In other words, the DVS 511 may transmit images to the processor 515 only when a moving event occurs. As such, when an object is stationary, the DVS 511 does not perform image processing and, only when the object moves, the DVS 511 may capture the moving object and transmit to the processor 515. A detailed configuration of the DVS 511 is described below with reference to FIGS. 6 and 7.

Upon receiving a compressed image from the DVS 511, the image processing unit 513 decompresses the received image and shrinks the decompressed image by resizing.

The processor 515 may control the overall operation of the motion detection device 501. For example, the processor 515 may control the DVS 511, the image processing unit 513, the processor 515, the communication circuit 519, the user interface 521, and the output unit 523 by executing programs stored in the memory 517.

The processor 515 may receive a plurality of images including a movable object using the DVS 511 for a predetermined time and generate data for determining a kind of motion of the object based on a motion vector for the plurality of images.

The processor 515 may receive a plurality of images from the image processing unit 513 for a predetermined time, divide the plurality of images into a plurality of groups each of which includes a predetermined number of images in the order of receiving the plurality of images, and generate a plurality of motion vector images including a motion vector for the plurality of images in each of the plurality of groups.

For example, when the processor 515 receives 30 frames per second, the processor 515 may receive 120 frames every four seconds, divide 120 frames received for four seconds into 12 segments (8 frames per segment), and generate 12 motion vector images for the 12 segments in such a manner as to generate a motion vector image resulting from detecting a motion vector among the eight frames in a first segment and then generate a motion vector image resulting from detecting a motion vector among the eight frames in a second segment. The processor 515 may interpret the image feature (e.g., a motion vector) with eight frames and determine a kind of motion of the object temporarily in the image with 12 segments (8 frames per segment).

The processor 515 may generate depth information (e.g., a depth map) for each of the plurality of motion vector images using a depth measurement artificial neural network (e.g., a depth estimator convolution neural network (CNN)) for generating depth information which is stored in the memory 517.

The processor 515 may infer the mean distance between the DVS 511 of the motion detection device and the object in the plurality of images using the depth information (e.g., a depth map) for each of the plurality of motion vector images and detect the inferred mean distance as distance information between the DVS 511 and the object in the plurality of images.

The processor 515 may transmit at least one piece of data for determining the kind of motion of the object to the cloud and determine the kind of motion of the object based on information received from the cloud.

The processor 515 may transmit, in order, the depth information (e.g., a depth map) for each of the plurality of motion vector images which are data for determining the kind of motion of the object to the cloud 130.

The processor 515 may transmit, in order, the depth information (e.g., a depth map) for each of the plurality of motion vector images, which are data for determining the kind of motion of the object, and distance information, which is additional data for determining the kind of motion of the object, to the cloud 130.

The processor 515 may determine the kind of motion of the object in the plurality of images based on information received from the cloud 130.

When a learning model for determining the kind of motion of the object is stored in the memory 517, the processor 515 may apply, in order, the depth information (e.g., a depth map) for each of the plurality of motion vector images, which are determining the kind of motion of the object, to the learning model, for determining the kind of motion of the object in the plurality of images.

The processor 515 may apply, in order, the depth information (e.g., a depth map) for each of the plurality of motion vector images, which are data for determining the kind of motion of the object, and distance information, which is additional data for determining the kind of motion of the object, to the learning model stored in the memory 517, for determining the kind of motion of the object in the plurality of images.

The memory 517 may store a program for processing and controlling the processor 515 and may store input/output data (e.g., still images or videos).

The memory 517 may include, e.g., an internal memory or an external memory. The internal memory may include at least one of, e.g., a volatile memory (e.g., a dynamic random access memory (DRAM), a static random access memory (SRAM), a synchronous DRAM (SDRAM), etc.) or a non-volatile memory (e.g., a one time programmable read only memory (OTPROM), a programmable read only memory (PROM), an erasable and programmable read only memory (EPROM), an electrically erasable and programmable read only memory (EEPROM), a mask read only memory (ROM), a flash ROM, a flash memory (e.g., a NAND flash memory, or a NOR flash memory), a hard drive, or solid state drive (SSD).

The external memory may include a flash drive, e.g., a compact flash (CF) memory, a secure digital (SD) memory, a micro-SD memory, a min-SD memory, an extreme digital (xD) memory, a multi-media card (MMC), or a memory stick. The external memory may be functionally and/or physically connected with the motion detection device 501 via various interfaces.

The memory 517 may store a depth measurement artificial neural network (e.g., a depth estimator CNN).

The memory 517 may store a learning model (e.g., a deep-learning model) for determining the kind of motion of the object. The learning model may periodically be updated with learning data received from a server 150. For example, the memory 517 may store the learning model (e.g., a deep-learning model) trained as shown in FIG. 3.

The communication circuit 519 may include one or more components that enable communication between the motion detection device 501 and a cloud 130 and/or communication between the motion detection device 501 and a server 150. For example, the communication circuit 519 may include, e.g., a short-range communication unit and/or a mobile communication unit.

The short-range communication unit may include, but is not limited to, a Bluetooth™ communication unit, a Bluetooth™ low energy (BLE) communication unit, a near-field communication (NFC) unit, a wireless local area network (LAN) wireless-fidelity (Wi-Fi) communication unit, a ZigBee communication unit, a communication unit according to a standard of the Infrared Data Association (IrDA), a Wi-Fi direct (WFD) communication unit, an ultra-wideband (UWB) communication unit, and/or an Ant+ communication unit.

The mobile communication unit transmits/receives wireless signals to/from at least one of a base station, an external terminal, and/or a server over a mobile communication network. The wireless signals may include voice call signals, video call signals, or other various types of data according to transmission/reception of text/multimedia messages. The mobile communication unit may use at least one of, e.g., long term evolution (LTE), long term evolution-advanced (LTE-A), code division multiple access (CDMA), wideband code division multiple access (WCDMA), universal mobile telecommunication system (UMTS), wireless broadband (WiBro), or global system for mobile communication (GSM).

The user interface 521 may receive an input for setting a privacy level in a space where the DVS 511 is installed. The user interface 521 may receive an input for setting the sharpness of the image obtained via the DVS 511.

The output unit 523 is intended for outputting video signals, audio signals, or vibration signals, and the output unit 523 may include a display unit, a sound output unit, and/or a vibration motor. The display unit may display information processed in the motion detection device 501. For example, the display unit may display images obtained via the DVS 511, preview images, video file lists, or video playback screens. When the display unit and a touchpad are layered to constitute a touchscreen, the display unit may be used not only as an output device but also as an input device. The display unit may include at least one of a liquid crystal display, a thin film transistor liquid crystal display (TFT-LCD), an organic light-emitting diode (OLED) display, a flexible display, a 3D display, and/or an electrophoretic display. The sound output unit outputs audio data received from the communication circuit 519 or stored in the memory 517. The sound output unit outputs sound signals related to functions (e.g., generating an alert message) performed by the motion detection device 501. The sound output unit may include, e.g., a speaker and/or a buzzer.

FIG. 6 is an illustration 600 of a DVS according to an embodiment.

Referring to FIG. 6, the DVS 511 may include a grid of sensor pixels 601. The sensor pixels 601 may include any proper circuit and material that may provide detection of changes in lighting over time and a display of the changes.

Each of the sensor pixels 601 in one set is a pixel adjacent to at least one other pixel in the same set. Each of the sensor pixels 601 may include a photoreceptor 611, a differential circuit 612 (including a reset switch 613), and a comparator 614.

An incident light ray 602 may be detected by the photo receptor 611 (including, e.g., a photodiode). The optical current from the photoreceptor 611 may be converted into a voltage that is supplied to the differential circuit 612 (e.g., an amplified differential circuit) capable of detecting an increase or decrease in optical current via the comparator 614. An increase in optical current is detected as an ON event 615. For example, each of the sensor pixels 601 do not rely on charge collection as does an ordinary image sensor but rather directly measures the optical current in the photoreceptor 611. In the above configuration, the photodiode capacitance provides no constraint. Thus, the configuration may advantageously provide a high dynamic range unlike the conventional sensor pixel. Each of the sensor pixels 601 of the DVS 511 may achieve a dynamic range of, e.g., 120 dB.

FIG. 7 is a timing chart 700 for a certain pixel of a DVS according to an embodiment.

Referring to FIG. 7, a light level (e.g., illuminance or intensity) at the certain pixel may increase or decrease over time as indicated with the absolute intensity of pixel intensity (701), and an ON event 702 (corresponding to, e.g., an increase in the absolute intensity) and an OFF event 703 (corresponding to, e.g., a decrease in the absolute intensity) may be detected.

As shown in connection with the ON event 704, when the light level sharply increases, more ON events may occur continuously and rapidly. Thereafter, the circuit may be stabilized and return to generation of an ON event and an OFF event which is triggered by a change in the absolute intensity.

The ON event 702 and the OFF event 703 may be included in a pixel signal which indicates a change, over time, in the pixel of the DVS. For example, the pixel signal may include information (including, e.g., the x,y pixel position or another identifier) for the pixel corresponding to the timing chart 710 and information indicating the ON event 702 and the OFF event 703.

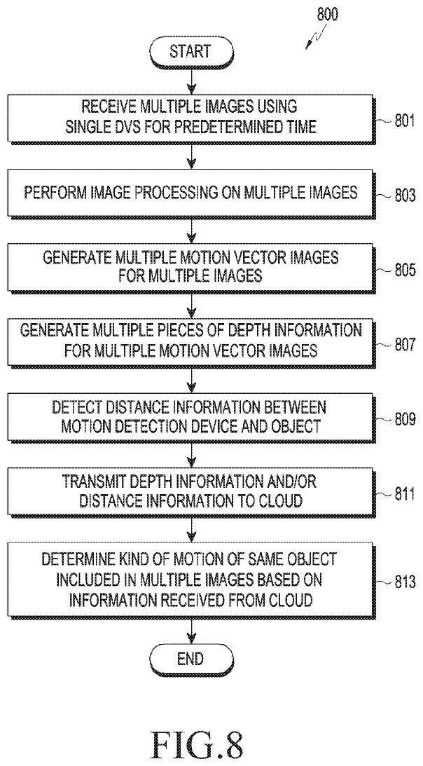

FIG. 8 is a flowchart 800 of a method of motion detection by a motion detection device according to an embodiment.

Referring to FIG. 8, the motion detection operations may include steps 801 to 813. The motion detection operations may be performed by a processor 515 of a motion detection device 501. At least one of steps 801 to 813 may be omitted, some steps may be performed in a different order, or other steps may be added.

In step 801, the processor may receive a plurality of images using a single DVS (e.g., the DVS 511 for a predetermined time.

In step 803, the processor may perform image processing on the plurality of images. The processor may control the image processing unit 513 to decompress each of the plurality of images and resize the images.

In step 805, the processor may generate a plurality of motion vector images for the plurality of images.

The processor may divide the plurality of images into a plurality of groups, where each of which includes a predetermined number of images, and generate a plurality of motion vector images including a motion vector for the plurality of images in each of the plurality of groups. The processor may individually generate the plurality of motion vector images for the plurality of groups by, e.g., an optical flow method as shown in FIG. 4.

In step 807, the processor may generate depth information (e.g., a depth map) for each of the plurality of motion vector images.

The processor may individually generate a plurality of pieces of depth information (e.g., a depth map) for the plurality of motion vector images using a depth measurement artificial neural network (e.g., a depth estimator CNN) for generating depth information and generate the plurality of pieces of depth information as data for determining a kind of motion of an object.

In step 809, the processor may determine distance information between the motion detection device and the object, as additional data for determining the kind of motion of the object, based on the plurality of pieces of depth information.

The processor may infer a mean distance between the DVS 511 of the motion detection device and the object in the plurality of images using the depth information (e.g., a depth map) for each of the plurality of motion vector images and detect the inferred mean distance as distance information between the DVS and the object in the plurality of images.

In step 811, the processor may transmit the data (e.g., depth information (e.g., a depth map)) for determining the kind of motion of the object and additional data (e.g., distance information) for determining the kind of motion of the object to a cloud 130 that stores a learning model for determining the kind of motion of the object.

In step 813, the processor may determine the kind of motion of the object in the plurality of images based on information received from the cloud.

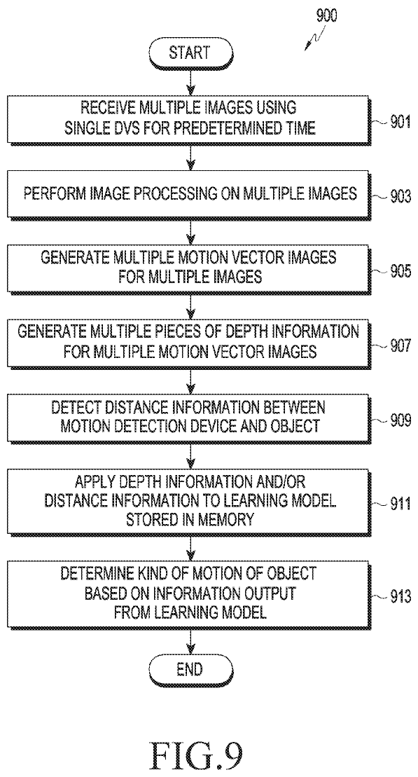

FIG. 9 is a flowchart 900 of a method of motion detection by a motion detection device according to an embodiment.

Referring to FIG. 9, the motion detection operations may include steps 901 to 913. The motion detection operations may be performed by a processor 515 of a motion detection device 501. At least one of steps 901 to 913 may be omitted, or some steps may be performed in a different order, or other steps may be added.

In step 901, the processor may receive a plurality of images using a single DVS 511 for a predetermined time.

In step 903, the processor may perform image processing on the plurality of images. The processor may control the image processing unit 513, decompressing each of the plurality of images and performing resizing on the images.

In step 905, the processor may generate a plurality of motion vector images for the plurality of images.

The processor may divide the plurality of images into a plurality of groups, each of which includes a predetermined number of images, and generate a plurality of motion vector images including a motion vector for the plurality of images in each of the plurality of groups. The processor may individually generate the plurality of motion vector images for the plurality of groups by, e.g., an optical flow method as shown in FIG. 4.

In step 907, the processor may generate depth information (e.g., a depth map) for each of the plurality of motion vector images.

The processor may individually generate a plurality of pieces of depth information (e.g., a depth map) for the plurality of motion vector images using a depth measurement artificial neural network (e.g., a depth estimator CNN) for generating depth information and determine the plurality of pieces of depth information as data for determining a kind of motion of an object.

In step 909, the processor may generate distance information between the motion detection device and the object, as additional data for determining the kind of motion of the object, based on the plurality of pieces of depth information.

The processor may infer a mean distance between the DVS 511 of the motion detection device and the object in the plurality of images using the depth information (e.g., a depth map) for each of the plurality of motion vector images and detect the inferred mean distance as distance information between the DVS and the object in the plurality of images.

In step 911, the processor may apply the data (e.g., depth information (e.g., a depth map)) for determining the kind of motion of the object or data (e.g., depth information (e.g., a depth map)) for determining the kind of motion of the object and additional data (e.g., distance information) for determining the kind of motion of the object to a learning model stored in the memory 517.

In step 913, the processor may determine the kind of motion of the object in the plurality of images based on information output from the learning model of the memory.

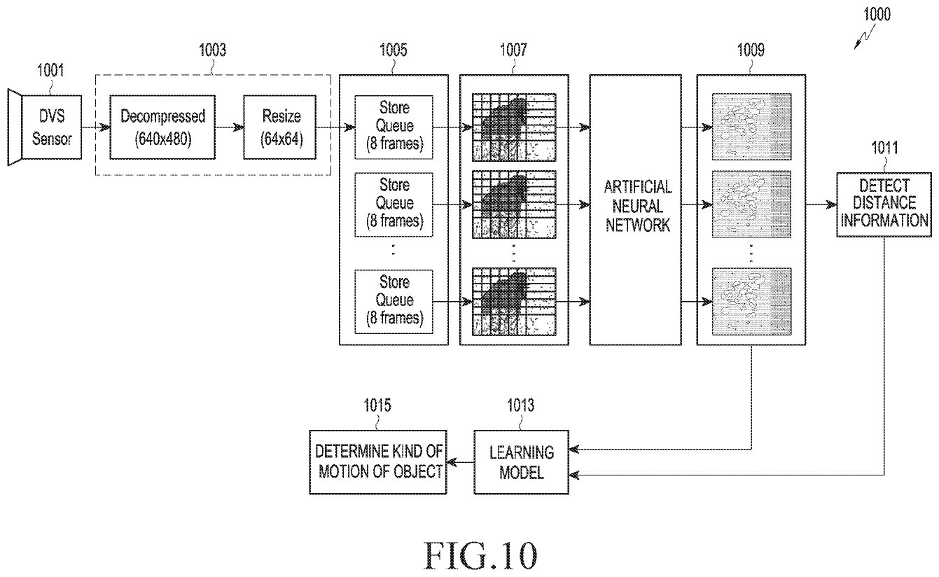

FIG. 10 is an illustration 1000 of an operation of motion detection by a motion detection device according to an embodiment.

Referring to FIG. 10, the motion detection operations may include steps 1001 to 1015. The motion detection operations may be performed by a processor 515 of a motion detection device 501. At least one of steps 1001 to 1015 may be omitted, some steps may be performed in a different order, or other steps may be added.

In step 1001, the processor may receive a plurality of images based on a DVS 511 for a predetermined time (e.g., four seconds).

In step 1003, the processor may control the image processing unit 513 to decompress the plurality of images in the order of reception and resize the 640*480 images into 64*64 images, where “*” indicates multiplication.

In step 1005, the processor may divide the plurality of images into a plurality of groups (e.g., 12 segments) each of which includes a predetermined number of images (e.g., eight frames).

In step 1007, the processor may generate a plurality of motion vector images for the plurality of images (e.g., eight frames) in each of the plurality of groups (e.g., 12 segments).

In step 1009, the processor may apply each of the plurality of motion vector images to the artificial neural network stored in the memory 517 to detect a plurality of pieces of depth information (e.g., a depth map) for each of the plurality of motion vector images.

In step 1011, the processor may infer a mean distance between the motion detection device (e.g., the motion detection device 501 of FIG. 5) and an object in the plurality of images using the depth information (e.g., a depth map) for each of the plurality of motion vector images and determine the inferred mean distance, as depth information between the motion detection device and the object in the plurality of images.

In step 1013, the processor may apply the depth information (e.g., a depth map) and/or distance information to a learning model stored in the cloud 130 or the learning model stored in the memory 517 of the motion detection device.

In step 1015, the processor may determine a kind of motion of the object in the plurality of images based on information output from the learning model.

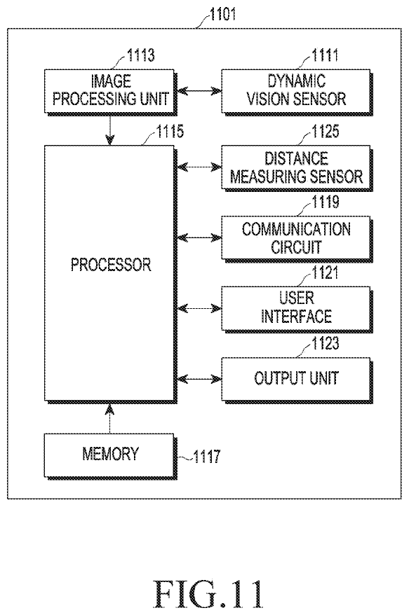

FIG. 11 is a block diagram of a motion detection device 1101 according to an embodiment.

Referring to FIG. 11, the motion detection device 1101 may include a DVS 1111, an image processing unit 1113, a processor 1115, a memory 1117, a communication circuit 1119, a user interface 1121, an output unit 1123, and a distance measuring sensor 1125.

The DVS 1111, image processing unit 1113, memory 1117, communication circuit 1119, user interface 1121, and output unit 1123 of FIG. 11 are operated in the same manner as the DVS 511, the image processing unit 513, the memory 517, the communication circuit 519, the user interface 521, and the output unit 523 of FIG. 5 and, therefore, no description thereof is given below.

The processor 1115 may control the overall operation of the motion detection device 1101. For example, the processor 1115 may control the DVS 1111, the image processing unit 1113, the processor 1115, the communication circuit 1119, the user interface 1123, the output unit 1123, and the distance measuring sensor 1125 by executing programs stored in the memory 1117.

The processor 1115 may receive a plurality of images including a movable object using the DVS 1111 for a predetermined time and generate data for determining a kind of motion of an object based on the motion vector for the plurality of images.

The processor 1115 may receive a plurality of images from the image processing unit 1113 for a predetermined time, divide the plurality of images into a plurality of groups, where each of which includes a predetermined number of images in the order of receiving the plurality of images, and generate a plurality of motion vector images including a motion vector for the plurality of images in each of the plurality of groups.

For example, when the processor 1115 receives 30 frames per second, the processor 1115 may receive 120 frames every four seconds, divide 120 frames received for four seconds into 12 segments (8 frames per segment), and generate 12 motion vector images for the 12 segments in such a manner as to generate a motion vector image resulting from detecting a motion vector among the eight frames in a first segment and then generate a motion vector image resulting from detecting a motion vector among the eight frames in a second segment. The processor 1115 may interpret the image feature (e.g., motion vector) with eight frames and determine the kind of motion of the object temporarily in the image with 12 segments (8 frames per segment).

The processor 1115 may individually generate a plurality of pieces of depth information (e.g., a depth map) for the plurality of motion vector images using a depth measurement artificial neural network (e.g., a depth estimator convolution neural network (CNN)) for generating depth information which is stored in the memory 1117.

The processor 1115 may detect a mean distance between the DVS 1111 of the motion detection device and the object in the plurality of images based on sensor information received from the distance measuring sensor 1125 and determine the mean distance as distance information between the DVS 511 and the object in the plurality of images.

The processor 1115 may transmit at least one piece of data for determining the kind of motion of the object to the cloud and determine the kind of motion of the object based on information received from the cloud.

The processor 1115 may transmit, in order, the plurality of pieces of depth information (e.g., a depth map) for the plurality of motion vector images which are data for determining the kind of motion of the object to the cloud 130.

The processor 1115 may transmit, in order, the plurality of pieces of depth information (e.g., a depth map) for the plurality of motion vector images, which are data for determining the kind of motion of the object, and distance information, which is additional data for determining the kind of motion of the object, to the cloud 130.

The processor 1115 may determine the kind of motion of the same object in the plurality of images based on information received from the cloud 130.

When a learning model for determining the kind of motion of the object is stored in the memory 1117, the processor 1115 may apply, in order, the plurality of pieces of depth information (e.g., a depth map) for the plurality of motion vector images, which are for determining the kind of motion of the object, to the learning model to determine the kind of motion of the same object in the plurality of images.

The processor 1115 may apply, in order, the plurality of pieces of depth information (e.g., a depth map) for the plurality of motion vector images, which are data for determining the kind of motion of the object, and distance information, which is additional data for determining the kind of motion of the object, to the learning model stored in the memory 1117 to determine the kind of motion of the same object in the plurality of images.

The distance measuring sensor 1125 may measure a distance between the motion detection device 1101 and the object in the plurality of images and transmit sensor information corresponding to the measured distance to the processor 1115. The distance measuring sensor 1125 may include an ultrasonic sensor, a radar sensor, and/or a time-of-flight (ToF) sensor.

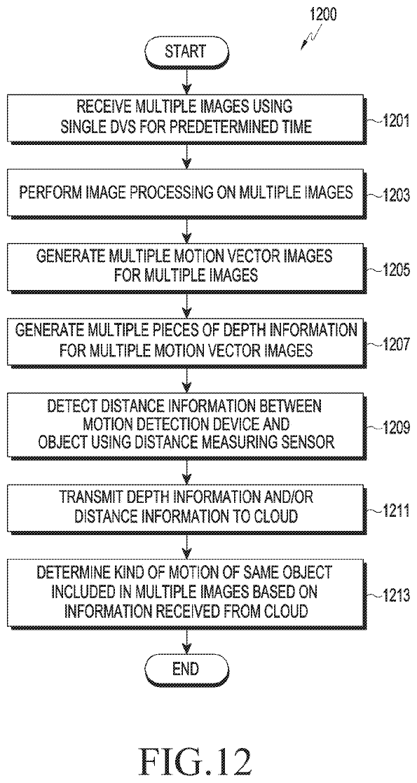

FIG. 12 is a flowchart 1200 of a method of motion detection by a motion detection device according to an embodiment.

Referring to FIG. 12, the motion detection operations may include steps 1201 to 1213. The motion detection operations may be performed by a processor 1115 of a motion detection device 1101. At least one of steps 1201 to 1213 may be omitted, some steps may be performed in a different order, or other steps may be added.

In step 1201, the processor may receive a plurality of images using a DVS 1111 for a predetermined time.

In step 1203, the processor may perform image processing on the plurality of images. The processor may control the image processing unit 1113 to decompress each of the plurality of images and resize the images.

In step 1205, the processor may generate a plurality of motion vector images for the plurality of images.

The processor may divide the plurality of images into a plurality of groups, each of which includes a predetermined number of images, and generate a plurality of motion vector images including a motion vector for the plurality of images in each of the plurality of groups. The processor may individually generate the plurality of motion vector images for the plurality of groups by, e.g., an optical flow method as shown in FIG. 4.

In step 1207, the processor may generate depth information (e.g., a depth map) for each of the plurality of motion vector images.

The processor may individually generate a plurality of pieces of depth information (e.g., a depth map) for the plurality of motion vector images using a depth measurement artificial neural network (e.g., a depth estimator CNN) for generating depth information and generate the plurality of pieces of depth information as data for determining a kind of motion of an object.

In step 1209, the processor may detect distance information between the motion detection device and the object using the distance measuring sensor 1125. The detected distance information may be generated as additional data for determining the kind of motion of the object.

In step 1211, the processor may transmit the data (e.g., depth information (e.g., a depth map)) for determining the kind of motion of the object or data (e.g., depth information (e.g., a depth map)) for determining the kind of motion of the object and additional data (e.g., distance information) for determining the kind of motion of the object to a cloud 130 that stores a learning model for determining the kind of motion of the object.

In step 1213, the processor may determine the kind of motion of the same object in the plurality of images based on information received from the cloud.

If the memory 1117 of the motion detection device stores a learning model for determining the kind of motion of the object, the processor may apply the data (e.g., depth information (e.g., a depth map)) for determining the kind of motion of the object or data (e.g., depth information (e.g., a depth map)) for determining the kind of motion of the object and additional data (e.g., distance information) for determining the kind of motion of the object to a learning model stored in the memory 1117. The processor may determine the kind of motion of the same object in the plurality of images based on information output from the learning model of the memory.

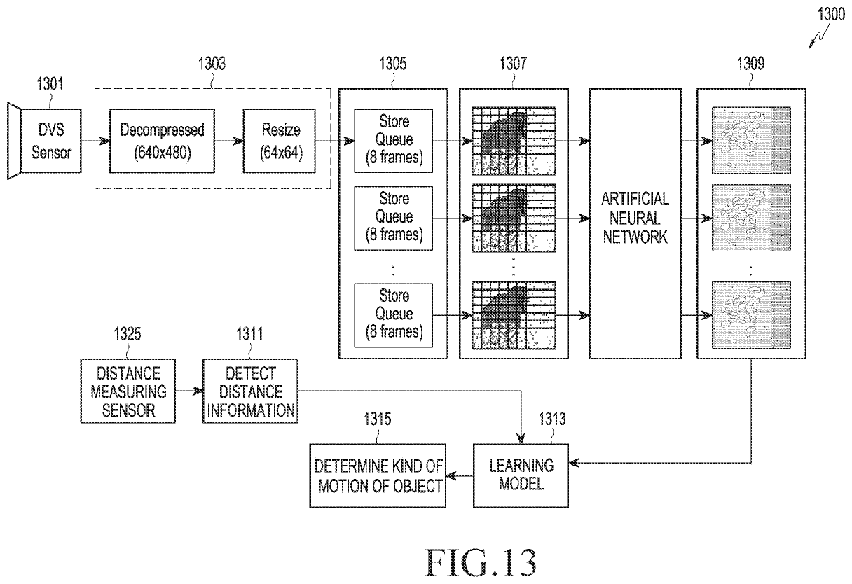

FIG. 13 is an illustration 1300 of a method of motion detection by a motion detection device according to an embodiment.

Referring to FIG. 13, the motion detection operations may include steps 1301 to 1325. The motion detection operations may be performed by a processor 1115 of a motion detection device 1101. At least one of steps 1301 to 1325 may be omitted, some steps may be performed in a different order, or other steps may be added.

Referring to FIG. 13, in step 1301, the processor may receive a plurality of images based on a DVS 1111 for a predetermined time (e.g., four seconds).

In step 1303, the processor may control the image processing unit 1113 to decompress the plurality of images in the order of reception and resize the decompressed 640*480 images into 64*64 images.

In step 1305, the processor may divide the plurality of images into a plurality of groups (e.g., 12 segments) each of which includes a predetermined number of images (e.g., eight frames).

In step 1307, the processor may generate a plurality of motion vector images for the plurality of images (e.g., eight frames) in each of the plurality of groups (e.g., 12 segments).

In step 1309, the processor may apply each of the plurality of motion vector images to the artificial neural network stored in the memory 1117 to detect depth information (e.g., a depth map) for each of the plurality of motion vector images.

In step 1311, the processor may detect distance information between the motion detection device 1101 and the object in the plurality of images based on sensor information received from the distance measuring sensor 1325.

In step 1313, the processor may apply the depth information (e.g., a depth map) and/or distance information to a learning model stored in the cloud 130 or a learning model stored in the memory 1117 of the motion detection device.

In step 1315, the processor may determine a kind of motion of the object in the plurality of images based on information output from the learning model of the cloud or memory.

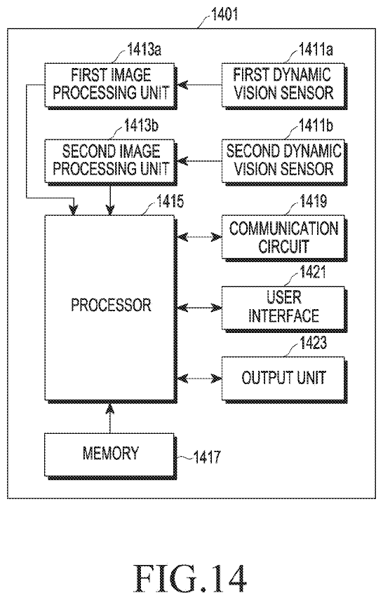

FIG. 14 is a block diagram of a motion detection device 1401 according to an embodiment. Referring to FIG. 14, the motion detection device 1401 may include a first DVS 1411a, a second DVS 1411b, a first image processing unit 1413a, a second image processing unit 1413b, a processor 1415, a memory 1417, a communication circuit 1419, a user interface 1421, and an output unit 1423.

The memory 1417, the communication circuit 1419, the user interface 1421, and the output unit 1423 of FIG. 14 are operated in the same manner as the memory 517, the communication circuit 519, the user interface 521, and the output unit 523 of FIG. 5 and, therefore, no description thereof is given below.

The first DVS 1411a and the second DVS 1411b of FIG. 14 are operated in the same manner as does the DVS 511 of FIG. 5, and, therefore, no detailed description thereof is given below.

The first image processing unit 1413a and the second image processing unit 1413b of FIG. 14 are operated in the same manner as does the image processing unit 513 of FIG. 5, and, therefore, no detailed description thereof is given below.

The processor 1415 may control the overall operation of the motion detection device 1401. For example, the processor 1415 may control the first DVS 1411a, the second DVS 1411b, the first image processing unit 1413a, the second image processing unit 1413b, the memory 1417, the communication circuit 1419, the user interface 1421, and the output unit 1423 by executing programs stored in the memory 1417.

The processor 1415 may generate depth information (e.g., a depth map) for the plurality of images using disparities between a plurality of first images received using the first DVS 1411a and a plurality of second images received using the second DVS 1411b.

The processor 1415 may receive the plurality of first images including a movable object using the first DVS 1411a for a predetermined time and divide the plurality of first images into a plurality of first groups, each of which includes a plurality of number of images, in the order of receiving the plurality of first images.

The processor 1415 may receive the plurality of second images including a movable object using the second DVS 1411b for a predetermined time and divide the plurality of second images into a plurality of second groups, each of which includes a plurality of number of images, in the order of receiving the plurality of second images.

The processor 1415 may detect depth information (e.g., a depth map) for each of the plurality of groups based on disparities between the plurality of first images in each of the plurality of first groups and the plurality of second images in each of the plurality of second groups. For example, the processor 1415 may detect depth information (e.g., a depth map) for each of the plurality of groups using an arithmetic method, e.g., trigonometry.

The processor 1415 may infer a mean distance between the motion detection device 1401 and the object in the plurality of images using the depth information (e.g., a depth map) for each of the plurality of motion vector images and determine the inferred mean distance as distance information between the motion detection device 1401 and the object in the plurality of images.

The processor 1415 may transmit at least one piece of data for determining a kind of motion of the object to the cloud and determine the kind of motion of the object based on information received from the cloud.

The processor 1415 may transmit, in order, the depth information (e.g., a depth map) for each of the plurality of motion vector images which are data for determining the kind of motion of the object to the cloud 130.

The processor 1415 may transmit, in order, the depth information (e.g., a depth map) for each of the plurality of motion vector images, which are data for determining the kind of motion of the object, and distance information, which is additional data for determining the kind of motion of the object, to the cloud 130.

The processor 1415 may determine the kind of motion of the same object in the plurality of images based on information received from the cloud (e.g., the cloud 130 of FIG. 1).

When a learning model for determining the kind of motion of the object is stored in the memory 1417, the processor 1415 may apply, in order, the depth information (e.g., a depth map) for each of the plurality of motion vector images, which are for determining the kind of motion of the object, to the learning model to determine the kind of motion of the same object in the plurality of images.

The processor 1415 may apply, in order, the depth information (e.g., a depth map) for each of the plurality of motion vector images, which are data for determining the kind of motion of the object, and distance information, which is additional data for determining the kind of motion of the object, to the learning model stored in the memory 1417 to determine the kind of motion of the object in the plurality of images.

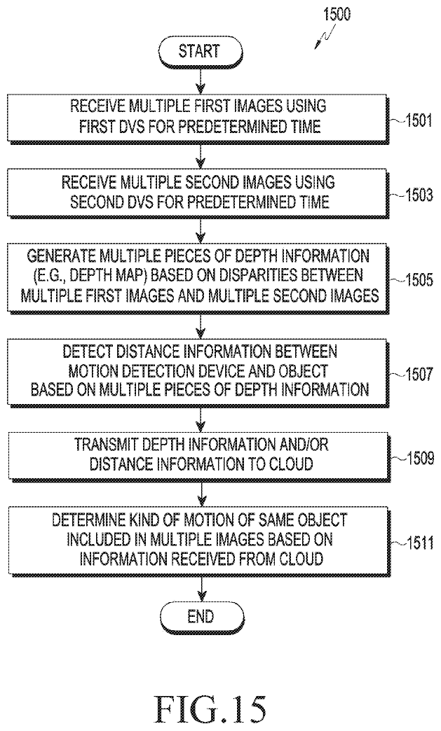

FIG. 15 is a flowchart 1500 of a method of motion detection by a motion detection device according to an embodiment.

Referring to FIG. 15, the motion detection operations may include steps 1501 to 1511. The motion detection operations may be performed by a processor 1415 of a motion detection device 1401. At least one of steps 1501 to 1511 may be omitted, some steps may be performed in a different order, or other steps may be added.

In step 1501, the processor may receive a plurality of first images using a first DVS 1411a for a predetermined time.

The processor may control the first image processing unit 1413a to decompress each of the plurality of first images and resize the first images.

In step 1503, the processor may receive a plurality of second images using a second DVS 1411b for a predetermined time.

The processor may control the second image processing unit 1413b to decompress each of the plurality of second images and resize the second images.

In step 1505, the processor may generate a plurality of pieces of depth information for the plurality of images based on disparities between the plurality of first images and the plurality of second images and generate the depth information, as data for determining a kind of motion of an object.

The processor may divide the plurality of first images into a plurality of first groups, each of which includes a predetermined number of images, and divide the plurality of second images into a plurality of second groups, each of which includes a predetermined number of images. The processor may generate a plurality of pieces of depth information (e.g., a depth map) based on the disparities between the plurality of first images in the plurality of first groups and the plurality of second images in the plurality of second groups. For example, the processor may generate a plurality of pieces of depth information (e.g., a depth map) using an arithmetic method, e.g., trigonometry.

In step 1507, the processor may generate distance information between the motion detection device and the object, as additional data for determining the kind of motion of the object, based on the plurality of pieces of depth information.

The processor may infer a mean distance between the motion detection device 1401 and the object in the plurality of images using the plurality of pieces of depth information (e.g., a depth map) and determine an inferred mean distance as distance information between the motion detection device and the object in the plurality of images.

In step 1509, the processor may transmit the data (e.g., depth information (e.g., a depth map)) for determining the kind of motion of the object or data (e.g., depth information (e.g., a depth map)) for determining the kind of motion of the object and additional data (e.g., distance information) for determining the kind of motion of the object to a cloud 130 that stores a learning model for determining the kind of motion of the object.

In step 1511, the processor may determine the kind of motion of the object in the plurality of images based on information received from the cloud.

If the memory 1417 of the motion detection device stores a learning model for determining the kind of motion of the object, the processor may apply the data (e.g., depth information (e.g., a depth map)) for determining the kind of motion of the object or data (e.g., depth information (e.g., a depth map)) for determining the kind of motion of the object and additional data (e.g., distance information) for determining the kind of motion of the object to the learning model stored in the memory 1417. The processor may determine the kind of motion of the same object in the plurality of images based on information output from the learning model of the memory.

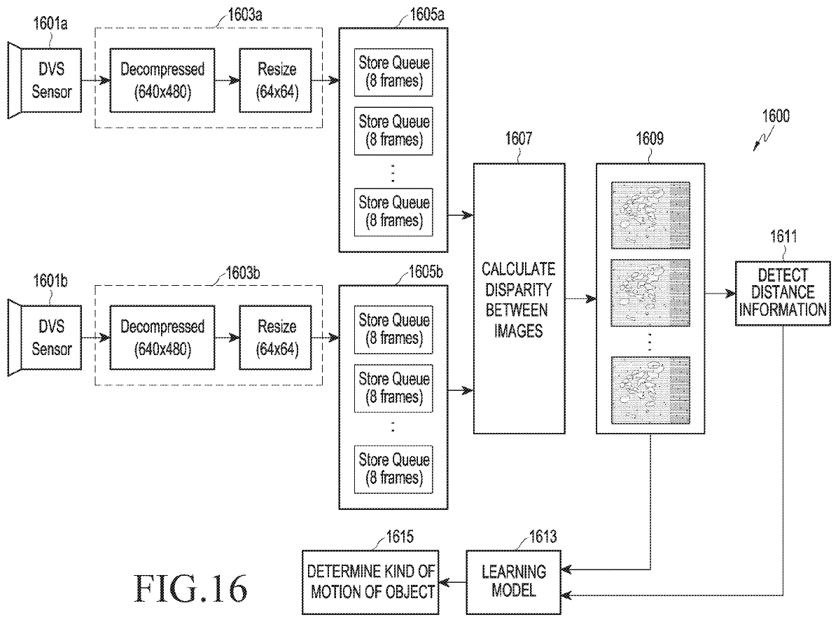

FIG. 16 is an illustration 1600 of a method of motion detection by a motion detection device according to an embodiment.

Referring to FIG. 16, the motion detection operations may include steps 1601a to 1615. The motion detection operations may be performed by a processor 1415 of a motion detection device 1401. At least one of steps 1601a to 1615 may be omitted, some steps may be performed in a different order, or other steps may be added.

In step 1601a, the processor may receive a plurality of first images based on a first DVS 1411a for a predetermined time (e.g., four seconds).

In step 1601b, the processor may receive a plurality of second images based on a second DVS 1411b for a predetermined time (e.g., four seconds).

In step 1603a, the processor may control the first image processing unit 1413a to decompress the plurality of first images in the order of reception and resize the 640*480 images into 64*64 images.

In step 1603b, the processor may control the second image processing unit 1413b to decompress the plurality of second images in the order of reception and resize the 640*480 images into 64*64 images.

In step 1605a, the processor may divide the plurality of first images into a plurality of first groups (e.g., 12 segments) each of which includes a predetermined number of images (e.g., eight frames).

In step 1605b, the processor may divide the plurality of second images into a plurality of second groups (e.g., 12 segments) each of which includes a predetermined number of images (e.g., eight frames).

In step 1607, the processor may calculate disparities between the plurality of first images (e.g., 8 frames) in each of the plurality of first groups and the plurality of second images (e.g., 8 frames) in each of the plurality of second groups.

In step 1609, the processor may determine a plurality of pieces of depth information (e.g., a depth map) based on the calculated disparities.

In step 1611, the processor may detect distance information between the motion detection device 1401 and the object in the plurality of images using the plurality of pieces of depth information (e.g., a depth map).

In step 1613, the processor may apply the depth information (e.g., a depth map) and/or distance information to the learning model stored in the cloud 130 or the learning model stored in the memory 1417 of the motion detection device.

In step 1615, the processor may determine a kind of motion of the object in the plurality of images based on information output from the learning model.

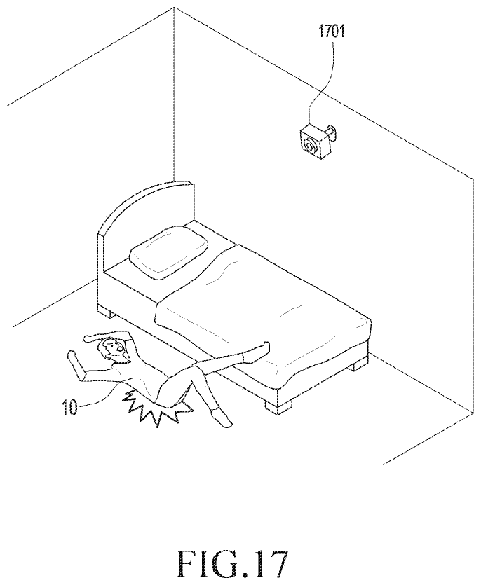

FIG. 17 is an illustration of an operation of motion detection by a motion detection device according to an embodiment.

Referring to FIG. 17, a dynamic motion detection device 1701 including at least one DVS may be installed in a position where motion of an object is detected.

The motion detection device 1701 may designate a certain object as its detection target based on a user input. For example, the motion detection device 1701 may specify human beings, except for animals, as targets for detection of falling. The motion detection device 1701 may designate a certain person as its monitoring target. For example if a mother, a father, a child and a grandfather are together at home, the grandfather may be designated as the target for detection of falling.

The motion detection device 1701 may determine a kind of motion of an object (e.g., a person) 10 in a danger detection context based on a user input. For example, there may be various dangerous situations, e.g., the object falling, a fire in the space where the object is in, a flood, a landslide, or gas leakage.

If the kind of motion of the object 10 is determined to be a dangerous situation (e.g., falling), the motion detection device 1701 may send out a notification for the dangerous situation of the object 10 at a preset phone number (e.g., home, hospital, and/or 911).

If the kind of motion of the object 10 is determined to be a dangerous situation (e.g., falling), the motion detection device 1701 may notify the family members in the house of the current situation of the object 10 by outputting, e.g., a sound.

The motion detection device may be one of various types of electronic devices. The motion detection device may include at least one of, e.g., a portable communication device (e.g., a smartphone), a computer device, a portable multimedia device, a portable medical device, a camera, a wearable device, or a home appliance. However, the motion detection device is not limited to those described above.

It should be appreciated that various embodiments of the disclosure and the terms used therein are not intended to limit the present disclosure but that various changes, equivalents, and/or replacements therefor also fall within the scope of the present disclosure. The same or similar reference denotations may be used to refer to the same or similar elements throughout the present disclosure and the accompanying drawings. It is to be understood that the singular forms “a,” “an,” and “the” include plural references unless the context clearly dictates otherwise. As used herein, the term “A or B,” “at least one of A and/or B,” “A, B, or C,” or “at least one of A, B, and/or C” may include all possible combinations of the enumerated items. As used herein, the terms “first” and “second” may modify various components regardless of importance and/or order and are used to distinguish a component from another component without limiting the components. It will be understood that when an element (e.g., a first element) is referred to as being (operatively or communicatively) “coupled with/to,” or “connected with/to” another element (e.g., a second element), the element may be coupled or connected with/to the other element directly or via a third element.

As used herein, the term “module” includes a unit configured in hardware, software, or firmware and may be used interchangeably with other terms, e.g., “logic,” “logic block,” “part,” or “circuit.” A module may be a single integral part or a minimum unit or part for performing one or more functions. For example, a module may be configured in an application-specific integrated circuit (ASIC).

Various embodiments as set forth herein may be implemented as software (e.g., the program 140) containing commands that are stored in a machine (e.g., a computer)-readable storage medium (e.g., an internal memory 136) or an external memory 138. The machine may be a device that may invoke a command stored in the storage medium and may be operated as per the invoked command. The machine may include an electronic device (e.g., the electronic device 101) according to embodiments disclosed herein. When the command is executed by a processor (e.g., the processor 120), the processor may perform a function corresponding to the command on its own or using other components under the control of the processor. The command may contain code that is generated or executed by a compiler or an interpreter. The machine-readable storage medium may be provided in the form of a non-transitory storage medium. Here, the term “non-transitory” simply indicates that the storage medium does not include a signal but is tangible, where this term does not differentiate between where data is semipermanently stored in the storage medium and where data is temporarily stored in the storage medium.

A method according to various embodiments of the disclosure may be included and provided in a computer program product. The computer program products may be traded as commodities between sellers and buyers. The computer program product may be distributed in the form of a machine-readable storage medium (e.g., a compact disc read only memory (CD-ROM)) or online through an application store (e.g., Playstore™). When distributed online, at least part of the computer program product may be temporarily generated or at least temporarily stored in a storage medium, such as the manufacturer's server, a server of the application store, or a relay server.

According to various embodiments, each component (e.g., a module or program) may be configured of a single or multiple entities, and the various embodiments may exclude some of the above-described sub components or add other sub components. Alternatively or additionally, some components (e.g., modules or programs) may be integrated into a single entity that may then perform the respective (pre-integration) functions of the components in the same or similar manner. According to various embodiments, operations performed by modules, programs, or other components may be carried out sequentially, in parallel, repeatedly, or heuristically, or at least some operations may be executed in a different order or omitted, or other operations may be added.

As is apparent from the foregoing description, according to various embodiments, it is possible to determine a kind of motion of an object without causing an invasion-of-privacy issue and to determine the kind of motion of the object even in a low-brightness environment (e.g., about 5 Lux). It is also possible to determine the kind of motion of the object with reduced performance and computation load as compared with the conventional way to use a 3D camera.

While the present disclosure has been shown and described with reference to certain embodiments thereof, it will be understood by those skilled in the art that various changes in form and details may be made therein without departing from the spirit and scope of the present disclosure as defined by the appended claims and their equivalents.

What is claimed is:

1. A motion detection device, comprising:
a first dynamic vision sensor (DVS);
a memory;
a communication circuit; and
at least one processor, wherein the at least one processor is configured to:
receive a plurality of images including a movable object using the first DVS for a predetermined time,
generate data for determining a kind of motion of the moveable object based on a motion vector of the plurality of images,
transmit the generated data to a cloud, and
determine the kind of motion of the moveable object based on information received from the cloud.

2. The motion detection device of claim 1, wherein the at least one processor is further configured to transmit the data for determining the kind of motion of the moveable object to the cloud that is configured to store a learning model for determining the kind of motion of the moveable object.

3. The motion detection device of claim 1, wherein the at least one processor is further configured to divide the plurality of images into a plurality of groups, wherein each of plurality of groups includes a predetermined number of images, generate a plurality of motion vector images including a motion vector for the predetermined number of images in each of the plurality of groups, generate a plurality of pieces of depth information based on the plurality of motion vector images, and transmit the plurality of pieces of depth information, as the data for determining the kind of motion of the moveable object, to the cloud.

4. The motion detection device of claim 3, wherein the at least one processor is further configured to detect distance information between the motion detection device and the moveable object based on the plurality of pieces of depth information and transmit the distance information, as additional data for determining the kind of motion of the moveable object, to the cloud.

5. The motion detection device of claim 1, further comprising a distance measuring sensor, wherein the at least one processor is further configured to transmit distance information between the motion detection device and the moveable object detected based on the distance measuring sensor, as additional data for determining the kind of motion of the moveable object, to the cloud.

6. The motion detection device of claim 1, further comprising a second DVS, wherein the at least one processor is further configured to receive a plurality of first images including the moveable object using the first DVS for a predetermined time, receive a plurality of second images including the moveable object using the second DVS for the predetermined time, generate the data for determining the kind of motion of the moveable object based on a disparity between the plurality of first images and the plurality of second images, and transmit the generated data to the cloud.

7. The motion detection device of claim 6, wherein the at least one processor is further configured to generate a plurality of pieces of depth information based on the disparity between the plurality of first images and the plurality of second images and transmit the plurality of pieces of depth information, as the data for determining the kind of motion of the moveable object, to the cloud.

8. The motion detection device of claim 7, wherein the at least one processor is further configured to detect distance information between the motion detection device and the moveable object based on the plurality of pieces of depth information and transmit the distance information, as additional data for determining the kind of motion of the moveable object, to the cloud.

9. The motion detection device of claim 1, wherein the memory is further configured to store a learning model for determining the motion of the moveable object, and the at least one processor is further configured to generate the data for determining the kind of motion of the moveable object based on the motion vector of the plurality of images, and apply the data to the learning model to determine the kind of motion of the moveable object.

10. The motion detection device of claim 9, wherein the memory is further configured to update the learning model stored in the memory with learning data periodically received from a server.

11. A method of detecting motion by a motion detection device, the method comprising:
receiving a plurality of images including a movable object using a first dynamic vision sensor (DVS) for a predetermined time;
generating data for determining a kind of motion of the moveable object based on a motion vector of the plurality of images;
transmitting the generated data to a cloud; and
determining the kind of motion of the moveable object based on information received from the cloud.

12. The method of claim 11, wherein transmitting the generated data to the cloud comprises transmitting the data for determining the kind of motion of the moveable object to the cloud configured to store a learning model for determining the motion of the moveable object.

13. The method of claim 11, wherein generating the data for determining the kind of motion of the moveable object comprises dividing the plurality of images into a plurality of groups, wherein each of the plurality of groups includes a predetermined number of the plurality of images, generating a plurality of motion vector images including a motion vector for the predetermined number of the plurality of images in each of the plurality of groups, generating a plurality of pieces of depth information based on the plurality of motion vector images, and transmitting the plurality of pieces of depth information, as the data for determining the kind of motion of the moveable object, to the cloud.

14. The method of claim 13, further comprising:
detecting distance information between the motion detection device and the moveable object based on the plurality of pieces of depth information; and
transmitting the distance information, as additional data for determining the kind of motion of the moveable object, to the cloud.

15. The method of claim 11, further comprising transmitting distance information between the motion detection device and the moveable object detected based on a distance measuring sensor, as additional data for determining the kind of motion of the moveable object, to the cloud.

16. The method of claim 11, further comprising:
receiving a plurality of first images including the moveable object using the first DVS for a predetermined time;
receiving a plurality of second images including the moveable object using a second DVS for the predetermined time;
generating the data for determining the kind of motion of the moveable object based on a disparity between the plurality of first images and the plurality of second images; and
transmitting the generated data to the cloud.

17. The method of claim 16, wherein generating the data for determining the kind of motion of the moveable object includes generating a plurality of pieces of depth information based on the disparity between the plurality of first images and the plurality of second images and transmitting the plurality of pieces of depth information, as the data for determining the kind of motion of the moveable object, to the cloud.

18. The method of claim 17, further comprising:
detecting distance information between the motion detection device and the moveable object based on the plurality of pieces of depth information; and
transmitting the distance information, as additional data for determining the kind of motion of the moveable object, to the cloud.

19. The method of claim 11, further comprising:
when a learning model for determining the motion of the moveable object is stored in a memory, generating the data for determining the kind of motion of the moveable object based on the motion vector of the plurality of images; and
applying the data to the learning model to determine the motion of the moveable object.

20. The method of claim 19, further comprising updating the learning model stored in the memory with learning data periodically received from a server.
